(19) United States
(12) Patent Application Publication
(10) Pub. No.: US 2026/0340338 A1
(43) Pub. Date: Oct. 29, 2026

(54) DISTRIBUTING INFERENCE WITH A LANGUAGE MODEL TO A PIPELINE OF COMPUTING EQUIPMENT

(71) Applicant: Dell Products L.P., Round Rock, TX (US)

(72) Inventors: Jeebak Mitra, Ottawa (CA); Gwenael Poitau, Montreal (CA)

(21) Appl. No.: 19/190,197

(22) Filed: Apr. 25, 2025

(51) Int. Cl. G06N 3/04

(52) U.S. Cl. CPC G06N 3/04

(57) ABSTRACT

The technologies described herein are generally directed to distributing inference with a language model to a pipeline of computing equipment. For instance, a system can, based on a resource availability table, identify a pipeline of compute nodes that process an inference request, based on different layers of a large language model, with the resource availability table being generated based on a first compute node of the pipeline of compute nodes. The system may, based on the resource availability table, communicate an input representation to the first compute node, and after processing the input representation, the first compute node communicates an intermediate representation to a second compute node of the pipeline. The system may further, based on an output representation, communicate a response to the inference request, with the output representation being received from the second node after processing the intermediate representation using a second layer of the large language model.

### BACKGROUND

As the applications of large language models expand, there is an escalating demand for efficient, fast, and cost-effective inference solutions. As the size performance of large language models has continued to increase, the associated rapid growth in memory and compute requirements has often outpaced the development of the hardware used for training and inference.

Designing systems that are used for inference with large language models involves different considerations, including system capabilities, data privacy and security, communication performance, and transmission overhead. In some circumstances, timing bottlenecks may reduce the usefulness of language models for certain applications.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, based on a resource availability table, identifying, by computing equipment that includes at least one processor, a pipeline of compute nodes respectively configured to process an inference request, based on different layers of a large language model, with the resource availability table being generated based on a characteristic of a first compute node of the pipeline of compute nodes. The method may further include, based on the resource availability table, communicating, by the computing equipment to the first compute node, an input representation of the inference request, and after processing the input representation using a first layer of the large language model, the first compute node communicates an intermediate representation to a second compute node of the pipeline of compute nodes. The method may further include, based on an output representation, communicating a response to the inference request, and the output representation was received from the second node after processing the intermediate representation using a second layer of the large language model.

Additionally or alternatively, a characteristic of the large language model may include at least one of a first characteristic representative of a number of parameters of the large language model, a second characteristic representative of a layer depth of the model, or a third characteristic representative of an average number of input tokens per inference request. Additionally or alternatively, the second compute node was selected to receive the intermediate representation based on the resource availability table. Additionally or alternatively, the method may further include, before the second compute node was selected, identifying a cause to modify the pipeline of compute nodes, and based on the cause, altering the resource availability table to specify the second compute node to receive the intermediate representation, and, before the altering, the resource availability table specified another compute node to receive the intermediate representation.

Additionally or alternatively, the cause to modify the pipeline of compute nodes may include at least one of a first cause representative of a dimensional incompatibility between the first compute node and the other compute node, a second cause representative of a failure of the other compute node, or a third cause representative of a workload of the other compute node. Additionally or alternatively, the resource availability table was generated to include the second compute node based on a node characteristic of the second compute node that includes at least one of a first node characteristic representative of a compute capacity of a graphics processor unit of the second node, a second node characteristic representative of a reliability of the second compute node, or a third node characteristic representative of a dimensional compatibility of the intermediate representation and the second compute node.

Additionally or alternatively, the method may further include receiving an indication from the second node that includes at least one of a first indication representative of a node characteristic of the second compute node, a second indication that the second compute node is available for inclusion in the resource availability table, or a third indication representative of a request by the second compute node to be included in the pipeline of compute nodes. Additionally or alternatively, the method may further include receiving, by the computing equipment from an input representation router, a model indication including a designation of the large language model for usage to process the input representation,

Additionally or alternatively, the method may further include, based on the designation, selecting the resource availability table from resource availability tables installed at compute nodes of the pipeline, resulting in a selected resource availability table, with the input representation further including table information representative of the selected resource availability table. Additionally or alternatively, the large language model was preloaded on the second compute node before the intermediate representation was received by the second compute node. Additionally or alternatively, the resource availability table was preloaded on the second compute node before the intermediate representation was received by the second compute node.

Additionally or alternatively, the method may further include, based on the resource availability table and an acknowledgement signal received from the first compute node, estimating that the first compute node is not in an outage state and is capable of processing the input representation using the first layer. Additionally or alternatively, the method may further include receiving a first ping signal from the second compute node, with the first ping signal being communicated by the second compute node in response to a second ping signal from the first compute node. Additionally or alternatively, the method may further include, based on the receiving of the first ping signal, determining that the processing of the inference request by the pipeline of the compute nodes is not in the outage state. Additionally or alternatively, the method may further include, based on an indication received from the first compute node, estimating that the second compute node is not in the outage state and is capable of the processing of the intermediate representation using the second layer.

Additionally or alternatively, the acknowledgement signal may include an acknowledgement of a receipt of a third ping signal communicated by the computing equipment, and the determining that the processing of the inference request is not in the outage state resulted from analysis of a duration measured from communication of the third ping signal to receipt of the first ping signal. Additionally or alternatively, the method may further include, identifying a fourth compute node that includes a first capability to transform the intermediate representation using the second layer of the large language model, and based on a comparing of a second capability of the second compute node and the first capability of the fourth compute node, specifying in the resource availability table that the second compute node is designated to transform the intermediate representation using the second layer.

An example system can operate as follows. At least one memory may store computer executable instructions, and at least one processor may be configured to process the computer executable instructions that, when executed by the at least one processor, facilitate performance of operations that include communicating, to second computing equipment, a registration message that includes a characteristic of the first computing equipment, and, based on the registration message, the second computing equipment integrates the characteristic into a model pipeline map, with the model pipeline map being representative of a sequence of computing equipment configured to respectively process a user prompt in consecutive compute stages of a generative model. The operations may further include, based on the model pipeline map and first intermediate data received from third computing equipment, processing the first intermediate data in accordance with a compute stage of the consecutive compute stages of the generative model, resulting in second intermediate data. The operations may further include, based on the model pipeline map, communicating, to fourth computing equipment, the second intermediate data, with the model pipeline map specifying that the fourth computing equipment is to transform the second intermediate data into output data responsive to the user prompt.

Additionally or alternatively, the model pipeline map may include a first model pipeline map that specifies that fifth computing equipment is to transform the second intermediate data into the output data. Additionally or alternatively, the operations may further include, before the first intermediate data is received, receiving the generative model and the first model pipeline map, and before the communicating of the second intermediate data, receiving update information representative of an update to the first model pipeline map, resulting in a second model pipeline map, with the communicating of the second intermediate data to the fourth computing equipment resulting from the update in the second model pipeline map.

Additionally or alternatively, the generative model may include a first generative model, and the sequence of computing equipment may include a first sequence of computing equipment. Additionally or alternatively, the operations may further include, before the first intermediate data is received, receiving a second generative model and a third model pipeline map representative a second sequence of computing equipment configured to respectively process the user prompt in consecutive compute stages of the second generative model, and before the first intermediate data is received from third computing equipment, receiving an indication that the first model pipeline map is designated to process the first intermediate data.

An example non-transitory machine-readable medium may include executable instructions that, when executed by at least one processor, facilitate performance of operations. The operations may include communicating a resource sequence specification table to a first computing node and a second computing node. The operations may further include, based on the resource sequence specification table, communicating, to the first computing node, an input representation of an inference request applicable to a language model, with the resource sequence specification table being employable to process the input representation by a sequence of computing nodes that include the first computing node and the second computing node. The operations may further include, based on an output representation, identifying a response to the inference request, and the output representation was received from the second computing node in accordance with processing by the sequence of computing nodes, as specified by the resource sequence specification table.

Additionally or alternatively, the resource sequence specification table may include a first resource sequence specification table, with the language model including a first language model. The operations may further include, before the input representation is communicated, communicating to the first computing node and the second computing node the first language model, a second language model, and a second resource sequence specification table applicable to the second language model.

Additionally or alternatively, the inference request includes a designation of the first language model as applicable to process the inference request, and the communicating of the input representation to the first computing node based on the first resource sequence specification table resulted from the designation of the first language model. Additionally or alternatively, the second computing node was selected for representation in the resource sequence specification table based on a predicted threshold level of reliability of the second computing node being above a threshold level of reliability.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate distributing inference with a language model to a pipeline of computing equipment, in accordance with one or more embodiments;

FIG. 2 is an architecture diagram of an example system that can facilitate distributing inference with a language model to a pipeline of computing equipment, in accordance with one or more embodiments;

FIG. 3 includes an architectural diagram that illustrates aspects of example system that can facilitate distributing inference with a language model to a pipeline of computing equipment, in accordance with one or more embodiments;

FIG. 4 includes a diagram of an example framework of inference servicing used by example system to facilitate distributing inference with multiple-language models to a pipeline of computing equipment, in accordance with one or more embodiments;

FIG. 5 includes a diagram of an example framework of inference servicing used by example system to facilitate distributing inference with a language model to a pipeline of computing equipment, in accordance with one or more embodiments;

FIG. 6 depicts a flow diagram representing example operations of an example method that can facilitate distributing inference with a language model to a pipeline of computing equipment, in accordance with one or more embodiments;

FIG. 7 depicts a flow diagram of an example system that can facilitate distributing inference with a language model to a pipeline of computing equipment, in accordance with one or more embodiments;

FIG. 8 depicts an example non-transitory machine-readable medium that can include executable instructions that, when executed by a processor of a system, can facilitate distributing inference with a language model to a pipeline of computing equipment, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of systems that employ machine learning language models, e.g., by providing approaches that facilitate the pipelined use of mid-to-high end personal compute devices to inference language models. Often, considerations of latency, performance, cost, security and the like, may prevent the use of language models for different applications. One or more embodiments described herein are not abstract concepts; rather, they provide technical solutions to technical problems associated with performing inference with language models using different hardware configurations. Implementations described herein can provide these solutions in a manner that cannot reliably be performed by a human or even a plurality of humans, e.g., solutions provided use linked personal computers to facilitate a pipeline of transformations of intermediate machine learning results that is not possible for one or a group of humans to perform.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

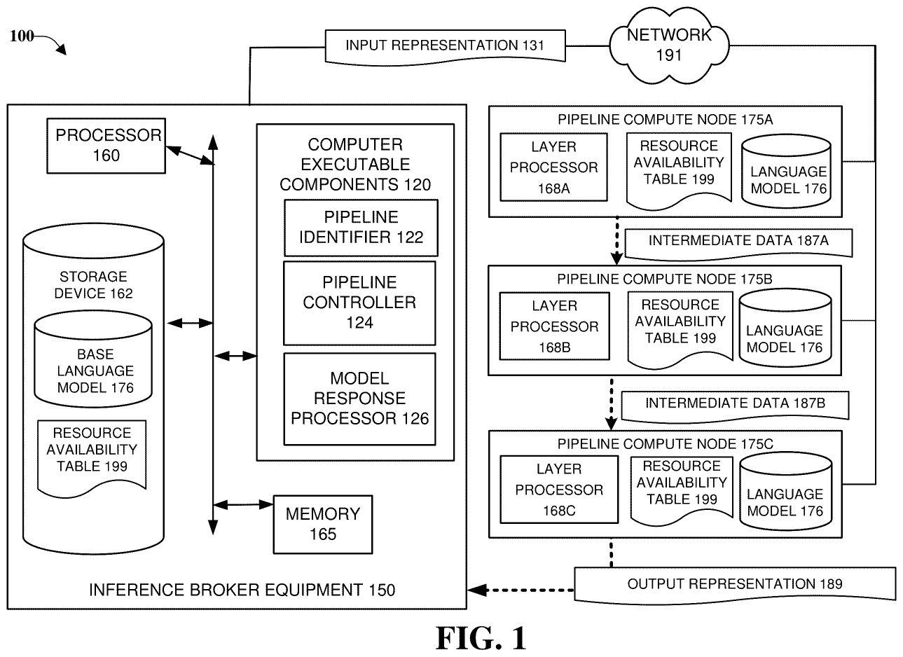

FIG. 1 is an architecture diagram of an example system 100 that can facilitate distributing inference with a language model to a pipeline of computing equipment, in accordance with one or more embodiments. For purposes of brevity, description of like elements and/or processes employed in other embodiments is omitted. As depicted, system 100 includes inference broker equipment 150 connected, via network 191, to pipeline compute nodes 175A-C, also termed compute devices, and the like, herein.

As depicted, inference broker equipment 150 can include memory 165 that can store one or more computer and/or machine readable, writable, and/or executable components 120 and/or instructions. In embodiments, inference broker equipment 150 can further include processor 160. In one or more embodiments, computer executable components 120, when executed by processor 160, can facilitate performance of operations defined by the executable component(s) and/or instruction(s). Computer executable components 120 can include pipeline identifier 122, pipeline controller 124, model response processor 126, and other components described or suggested by different embodiments described herein, that can improve the operation of system 100. Inference broker equipment 150 may further include storage device 162. In an example, storage device 162 may provide nonvolatile storage of data, data structures, computer executable instructions, and so forth. Storage device 162 includes resource availability table 199 and language model 176.

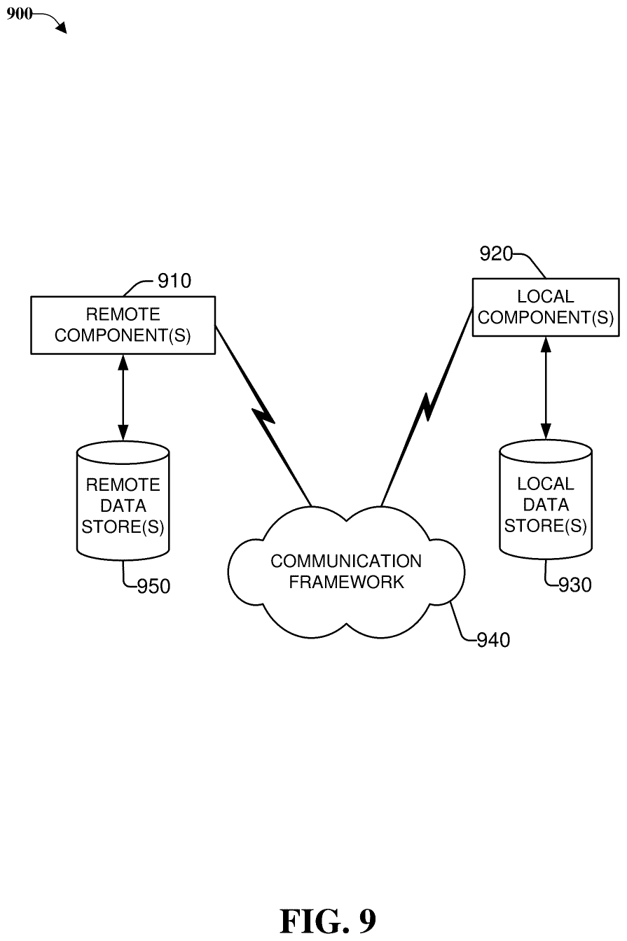

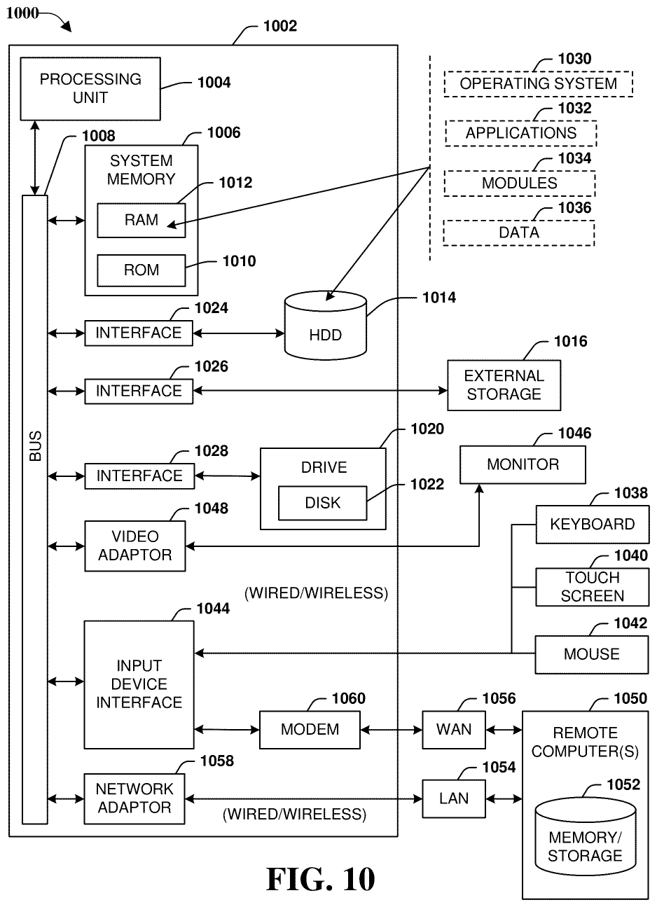

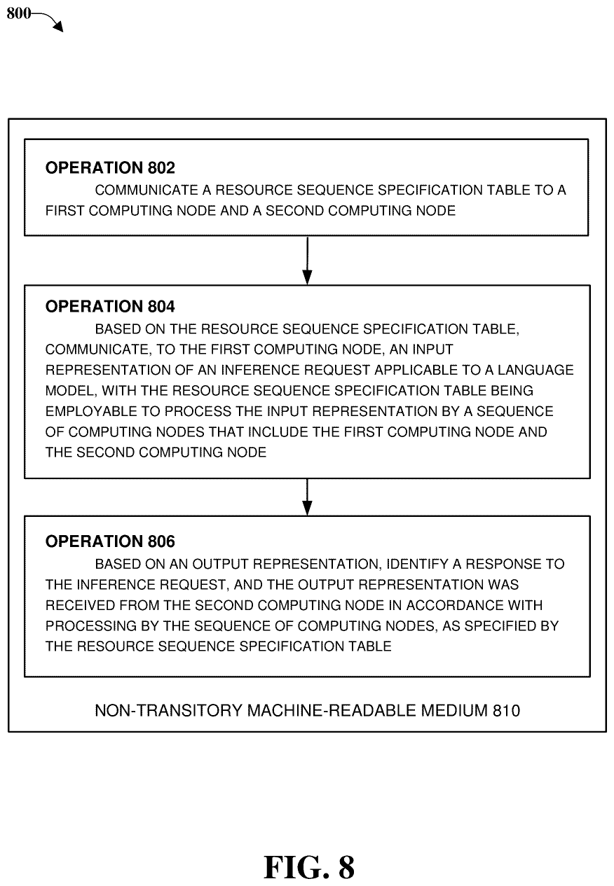

One or more embodiments may employ pipeline compute nodes with different capabilities. In a nonlimiting implementation, pipeline compute nodes 175A-C may be mid-to-high end personal compute devices with consumer-grade graphics processing units (GPUs) having features such as high raw performance per dollar, high energy efficiency, and decent burst performance, as compared with servers using enterprise-grade GPUs and specialized artificial intelligence processors. In other embodiments, any type of computer system described with FIGS. 9-10 below may be utilized. The discussion herein of the use of GPUs by compute nodes is non-limiting, with embodiments using processors generalized as xPUs, e.g., including a neural processing unit (NPU) custom designed to accelerate artificial intelligence and machine learning tasks. Stated differently, pipeline compute nodes 175A-C may be characterized as having heterogenous commoditized GPUs.

Pipeline compute nodes 175A-C respectively include layer processors 168A-C (also termed executable partitions, compute stages, the intermediary transformer layers, and the like herein), and instances of resource availability table 199 (also termed “resource sequence specification table,” and “model pipeline map,” herein) and language model 176, also termed large language model (LLM), generative model, and model, herein. Inference broker equipment 150 communicates input representation to pipeline compute node 175A via network 191. Pipeline compute node 175A communicates intermediate data 187A to pipeline compute node 175B after processing by layer processor 168A. Pipeline compute node 175B communicates intermediate data 187B to pipeline compute node 175C after processing by layer processor 168B. Pipeline compute node 175C communicates output representation 189 to inference broker equipment 150 after processing by layer processor 168C. Stated differently, outputs of the partition executed on the device (e.g., layer processors 168A-C) are passed on to the next device for execution of the next stage. In one or more embodiments, output representation 189 includes a probability mass function (PMF) of a first output token, e.g., obtained by applying a soft-max to the final linear layer.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate operation of pipeline identifier 122, which can in some implementations can, based on a resource availability table, identify a pipeline of compute nodes respectively configured to process an inference request, based on different layers of a large language model, with the resource availability table being generated based on a characteristic of a first compute node of the pipeline of compute nodes. For example, in one or more embodiments, pipeline identifier 122 may, based on a resource availability table, identify pipeline compute node 175A-C respectively configured to respectively process an inference request via layer processors 168A-C of language model 176, with resource availability table 199 being generated based on a characteristics of pipeline compute nodes 175A-C.

In another example, memory 165 can store executable instructions that can facilitate operation of pipeline controller 124, which in some implementations may, based on the resource availability table, communicate, by the computing equipment to the first compute node, an input representation of the inference request, and after processing the input representation using a first layer of the large language model, the first compute node communicates an intermediate representation to a second compute node of the pipeline of compute nodes. For example, in one or more embodiments, pipeline controller 124 can, based on resource availability table 199, communicate to pipeline compute node 175A, input representation 131, and after processing of the input representation using layer processor 168A, pipeline compute node 175A communicates intermediate data 187A to pipeline compute node 175B.

In another example, memory 165 can store executable instructions that can facilitate operation of model response processor 126, which in some implementations may, based on an output representation, communicate a response to the inference request, and the output representation was received from the second node after processing the intermediate representation using a second layer of the large language model. For example, in one or more embodiments, model response processor 126 may, based on output representation 189, communicate a response to the inference request, with the output representation being received from pipeline compute node 175C after processing of intermediate data 187B using layer processor 168C.

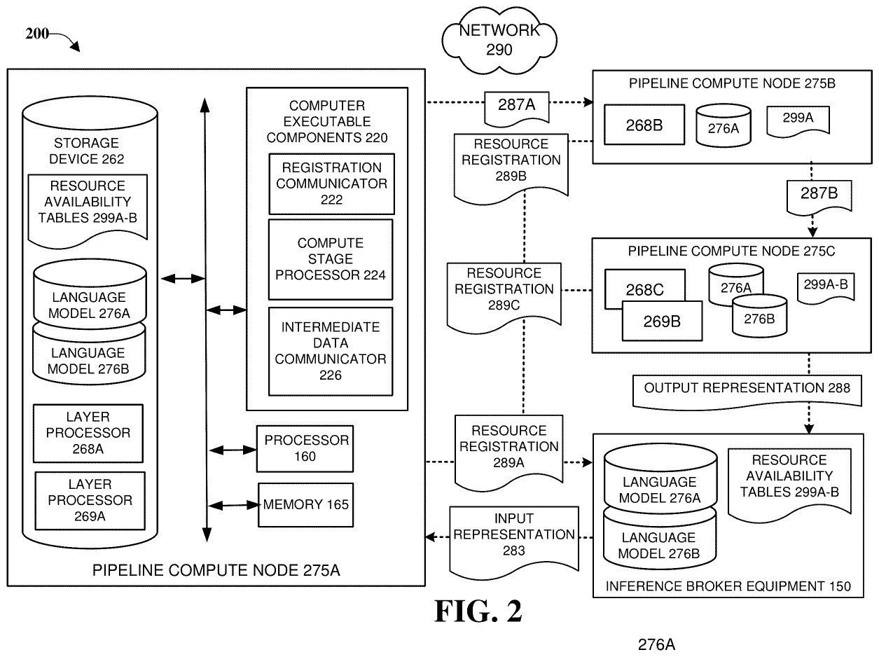

FIG. 2 is an architecture diagram of an example system 200 that can facilitate distributing inference with a language model to a pipeline of computing equipment, in accordance with one or more embodiments. For purposes of brevity, description of like elements and/or processes employed in other embodiments is omitted. As depicted, system 200 includes pipeline compute node 275A connected, via network 290 (not shown), to inference broker equipment 150 and pipeline compute nodes 275B-C. Pipeline compute node 175A includes processor 260, memory 265, storage device 262, and computer executable components 220.

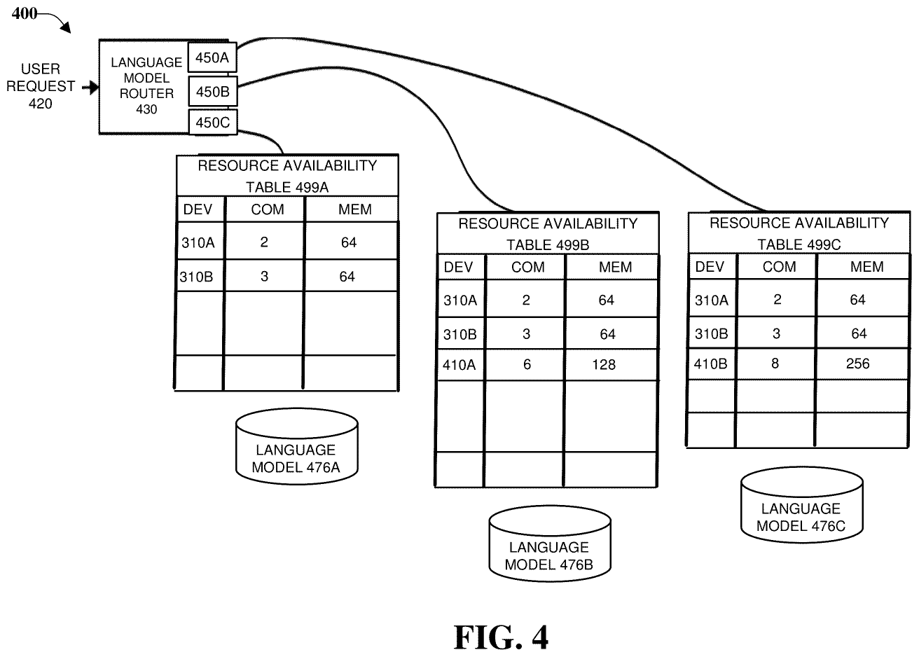

In embodiments, processor 260 is similar to processor 160 and storage device 262 is similar to storage device 162, discussed above. Storage device 262 includes resource availability tables 299A-B, language model 176A-B, and layer processors 268A-B. As discussed further with FIG. 4 below, in one or more embodiments, resource availability tables 299A-B, language model 176A-B, and layer processors 268A-B are preloaded on selected ones of pipeline compute nodes 275A-C, e.g., based on the pipelines specified by resource availability tables 299A-B.

Inference broker equipment 150 communicates input representation 283 to pipeline compute node 275A. In some embodiments, the pipeline compute nodes 275A-C of system 200, may be configured to respectively process inferences for language models 276A-B using a pipeline respectively specified by resource availability tables 299A-B. As discussed further with FIG. 4 below, in the example depicted, the example pipeline specified by resource availability table 299A for language model 276A includes a sequence of processing by layer processor 268A of pipeline compute node 275A (e.g., to produce intermediate data 287A), layer processor 268B of pipeline compute node 275B (e.g., to produce intermediate data 287B), and layer processor 268C of pipeline compute node 275C, e.g., to produce output representation 288. For language model 276B, the example pipeline is specified by resource availability table 299B, and proceeds from layer processor 269A of pipeline compute node 275A to layer processor 269B of pipeline compute node 275C, e.g., pipeline compute node 275B is not a part of the pipeline defined for language model 276B. Depending on the language model being processed, intermediate data 287A from pipeline compute node 275A may be communicated to layer processor 268B of pipeline compute node 275B (e.g., as described above) or intermediate data 287A may be communicated to layer processor 269B of pipeline compute node 275C (not shown).

According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include registration communicator 222, compute stage processor 224, intermediate data communicator 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of pipeline compute node 175A, memory 265 can store executable instructions that can facilitate operation of registration communicator 222, which, in some implementations, may communicate to second computing equipment, a registration message that includes a characteristic of the first computing equipment and, based on the registration message, the second computing equipment integrates the characteristic into a model pipeline map, with the model pipeline map being representative of a sequence of computing equipment configured to respectively process a user prompt in consecutive compute stages of a generative model.

As depicted, pipeline compute nodes 275A-C respectively communicate resource registrations 289A-C, to inference broker equipment 150. In one or more embodiments, resource registrations 289A-C communicate (also termed “advertise” herein) respective processing capabilities of pipeline compute nodes 275A-C to inference broker equipment 150 to facilitate the generation of resource availability tables 299A-B, e.g., selecting compute nodes for inference pipelines for language models based on characteristics of the language model to be handled. In other embodiments, a registration message may be communicated by a compute mode that indicates that the compute node is available for inclusion in a pipeline, a request that the compute node be included in pipeline, or a request that the compute node not be included in a pipeline.

In an example, different characteristics of language model 176 that were used to generate resource availability table 199 include, but are not limited to, a number of parameters of language model 176, a layer depth of language model 176, and/or an average number of input tokens per inference request submitted to language model 176. For example, a pipeline for a language model with a comparatively large number of parameters may have more compute nodes and/or compute nodes with higher compute capabilities. In another example, for a language model that supports an application of relatively higher importance, compute nodes that advertise (or have demonstrated) a higher level of reliability may be selected for inclusion in a resource availability table applicable to the language model.

Returning to FIG. 2, in one or more embodiments, registration communicator 222 may communicate to inference broker equipment 150, resource registration 289A that includes a characteristic of pipeline compute node 275A and, based on resource registration 289A, inference broker equipment 150 integrates pipeline compute node 275A and the characteristic into resource availability table 299A representative of a sequence of pipeline compute nodes 275A-C configured to respectively process a user prompt by layer processors 268A-C of language model 276A.

In an example implementation of pipeline compute node 175A, memory 265 can further store executable instructions that can facilitate operation of compute stage processor 224, which in some implementations, may, based on the model pipeline map and first intermediate data received from third computing equipment, process the first intermediate data in accordance with a compute stage of the consecutive compute stages of the generative model, resulting in second intermediate data. For example, in one or more embodiments, compute stage processor 224 may, based on resource availability table 299A and input representation 283 received from inference broker equipment 150, process input representation 283 in accordance with layer processor 268A (e.g., compute stage processor 224) of the consecutive compute stages of the language model 276A, resulting in intermediate data 287A.

In an example implementation of pipeline compute node 175A, memory 265 can further store executable instructions that can facilitate operation of intermediate data communicator 226, which in some implementations, may, based on the model pipeline map, communicate, to fourth computing equipment, the second intermediate data, with the model pipeline map specifying that the fourth computing equipment is to transform the second intermediate data into output data responsive to the user prompt. For example, in one or more embodiments, intermediate data communicator 226 may, based on the model pipeline map, communicate, to pipeline compute node 275B, intermediate data 287A, with resource availability table 299A specifying that pipeline compute node 275B is to transform intermediate data 287A into intermediate data 287B.

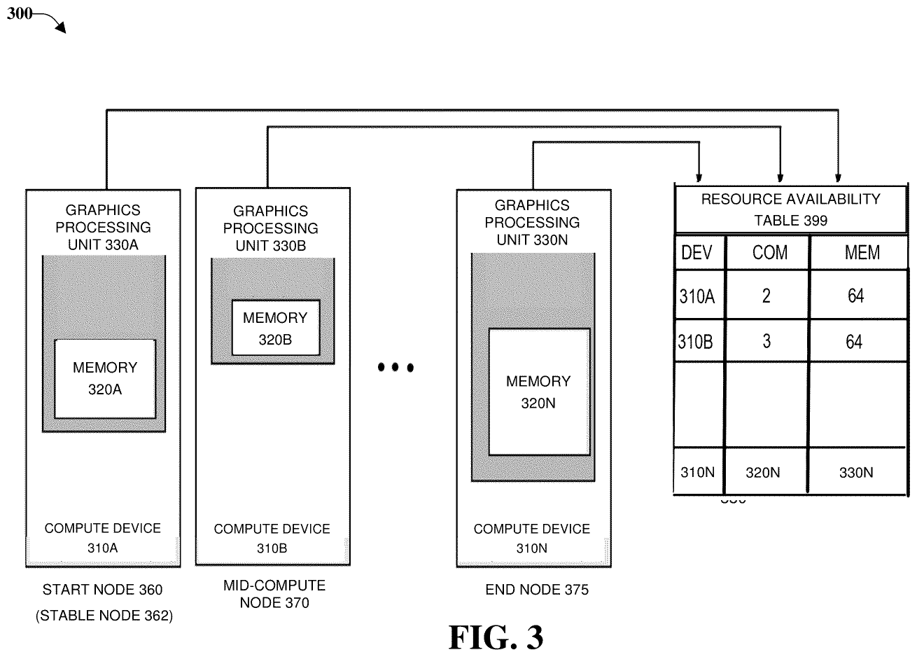

FIG. 3 includes an architectural diagram that illustrates aspects of example system 300 that can facilitate distributing inference with a language model to a pipeline of computing equipment, in accordance with one or more embodiments. For purposes of brevity, description of like elements and/or processes employed in other embodiments is omitted. System 300 includes compute devices 310A-N referenced by resource availability table 399. Resource availability table includes reference 309 to compute devices 310A-N, with respective compute capabilities (COM) and memory capabilities (MEM) of compute devices 310A-N, with memory capabilities 320A-N and GPU compute capabilities 330A-N being included in resource availability table 399. In one or more embodiments, one or more of compute devices 310A-N may be implemented as edge devices in a network having core and edge components.

In one or more embodiments, a resource availability table may be used by embodiments to divide a language model into separately executable partitions with each partition running on a separate compute device. Because embodiments facilitate the use of compute devices with varying capabilities (e.g., GPU compute capacity and the associated memory that the GPU can access) to perform inference on language models of different sizes, the compute devices selected to be included a resource availability table for a particular language model are selected based on the capabilities of the compute device.

For example, returning to the discussion of FIG. 2, to perform inference for language model 276A, resource availability table 299A includes a sequence of processing by pipeline compute node 275A-C, with these compute nodes being automatically selected by embodiments based on an analysis of factors including, but not limited to, the parameter size of the language model, communication times between compute nodes, and characteristics of the compute nodes.

FIG. 3 provides an example of this mapping of compute nodes of a pipeline to process inference with a language model. In this example, device reference (DEV) lists compute devices 310A-N, with respective GPU compute capabilities 330A-N and memory capabilities 320A-N of compute devices 310A-N, e.g., amount of memory available for use as well as memory bandwidth characteristics. This list of table attributes is nonlimiting, with different attributes also being beneficially included, e.g., communication characteristics of devices, security characteristics of devices, characteristics of respective executable partitions hosted by devices (e.g., layer processors 268A-B), the type of GPU (or NPU as discussed above), and reliability of respective devices. Additional characteristics of compute devices stored in resource availability tables are further discussed with resource registration messages herein. In one or more embodiments, the pipeline of compute nodes may be generated and maintained based on the dimensional compatibility of the tensor data transmitted from one node to another, e.g., pipeline compute node 275B may have been selected to receive intermediate data 287A from pipeline compute node 275A based on pipeline compute node 275B having dimensional compatibility with the tensor data included in intermediate data 287A.

The characteristics of resource availability tables facilitate the flexible use by embodiments of a collection of available compute nodes with different capabilities for inference of language models of different characteristics. As discussed further below, embodiments may utilize resource availability tables to enable dynamic changes to the compute nodes included in a pipeline, e.g., because of changes in device capabilities, outages of different devices, and any other characteristic used to select compute devices for inclusion in a particular resource availability table.

Continuing the example of FIG. 3, embodiments may be designated in the resource availability table to perform different pipeline functions, e.g., compute device 310A has been designated as start node 360, compute device 310B is a mid-compute node 370, and compute device 310N has been designated as end node 375. Criteria for selection of start node 360 and end node 375 include a measure of reliability of the nodes as compared to other nodes and/or a threshold of reliability. In terms of reliability start nodes 360 and end nodes 375 (also collectively termed “terminal nodes” by embodiments) may have the highest reliability, and mid-compute devices 370 will be from a pool of nodes. In one or more embodiments, the composition of nodes included in the resource availability table, as well as the order of nodes in the pipeline may be rebuilt dynamically periodically, e.g., to improve the likelihood that the autoregressive part of the language model inference has a robust pipeline.

In embodiments, at an initialization phase, start node 360 ingests an input from a tokenizer, e.g., hosted by inference broker equipment 150 or other equipment. In embodiments, an instance of the tokenizer of the language model may be available to compute devices 310A-N. Continuing this example, in embodiments, mid-compute nodes execute the intermediary transformer layers (e.g., layer processors 268A-C) of the language model and may implement more than one layer depending on the device capability.

One or more embodiments may avoid a pipeline stall using a variety of different processes. Before processing by the pipeline beings, selection of the composition and order of compute nodes in the resource availability table of a language model may reduce a likelihood of a stall based on an automatic selection of GPUs with sufficient compute capacity, and access to sufficiently high-speed memory.

During performance of the inference via the pipeline, embodiments may be configured to detect outages and other performance degradation in compute nodes of the pipeline. In an implementation, an outage in a compute node may be determined by a periodic ping initiated by start node 360 to its next node, mid-compute node 370, with the next node periodically sending back an acknowledgement signal (ACK) to start node 360. Continuing the check for outages, mid-compute node 370 may ping the next node in the pipeline, and may receive the periodic ACK therefrom. Eventually, the pipeline returns to start node 360, where upon successful receipt of a ping from end node 375, it is determined that no outages exist in the pipeline. Additionally or alternatively, ACKs may not be sent, with a time duration being applied by start node 360 for the receiving of the ping from end node 375. In an example where a node is determined to be in an outage condition, as a part of the process whereby embodiments may dynamically update the composition of resource availability table based on current conditions, the resource availability table may be updated to bypass the faulty node.

Continuing the discussion of the handling of failures within the pipeline, one or more embodiments may select a node to be designated as stable node 362. In some implementations, stable node 362 is designated to protect against loss of continuity in case of node failure, e.g., start node 360 may be further designated as stable node 362 at least because of the relatively higher reliability of nodes selected to be designated as start node 360.

FIG. 4 includes a diagram of an example framework of inference servicing used by example system 400 to facilitate distributing inference with multiple-language models to a pipeline of computing equipment, in accordance with one or more embodiments. For purposes of brevity, description of like elements and/or processes employed in other embodiments is omitted. System 400 includes language model router 430 receiving user request 420 and routing via selections 450A-C to resource availability tables 499A-C to inference language models 476A-C, respectively.

In some circumstances, language models 476A-C having different parameter sizes may have markedly different compute requirements and thus cause scenarios where it is beneficial to have more than one language model serving user requests depending on the complexity, and/or particular requirements of user request 420. One or more embodiments employ a framework is flexible enough to consider language models of different sizes using resource availability tables that are dynamically maintained.

For example, in system 400, embodiments facilitate use of one or more of multiple language models 476A-C with user request 420, e.g., language models of various sizes deployed using a varying number of intermediary nodes and a custom generated resource availability tables 499A-C to improve the likelihood of sufficient (collective) resource availability to handle user requests 420. As depicted, system 400 includes language model router 430 that takes in user request 420 and then parses the request as inputs to one or more of language models 476A-C.

In this example, available compute devices 310A-B and 310A-B are available for inclusion in compute pipelines for language models 476A-C, and a combination of nodes are selected for inclusion in resource availability tables 499A-C, respectively generated therefor. In this example, because language models 476A-C have different processing and/or reliability requirements, resource availability tables 499A-C include different combinations of resources. For example, for language library 476B, additional compute node 410A is added, having additional compute (COM) and available memory (MEM) resources, with compute node 410A being replaced by compute node 410B for language model 476C.

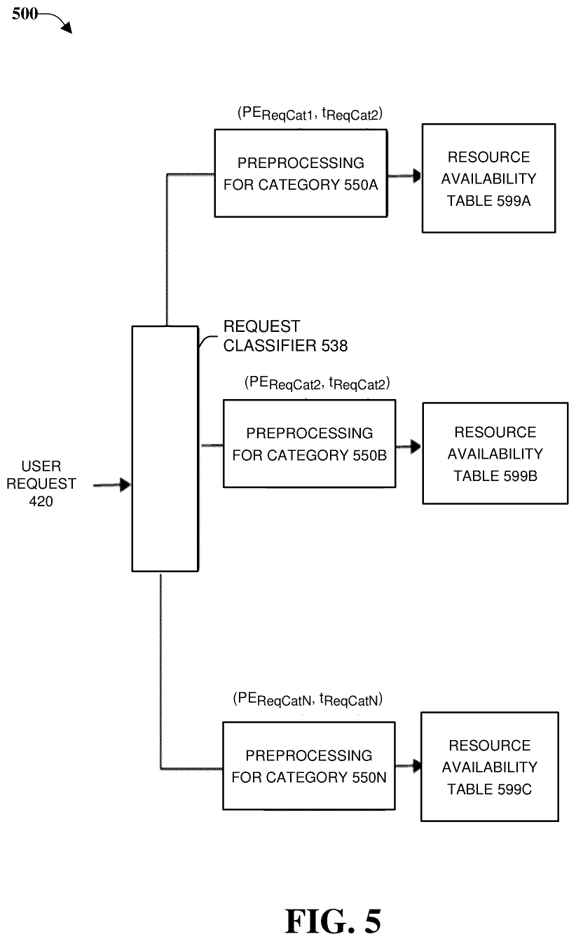

FIG. 5 includes a diagram of an example framework of inference servicing used by example system 500 to facilitate distributing inference with a language model to a pipeline of computing equipment, in accordance with one or more embodiments. For purposes of brevity, description of like elements and/or processes employed in other embodiments is omitted. System 500 includes request classifier 538 routing receiving user request 420 to be handled by resource availability tables 599A-C after respective preprocessing for categories 550A-C.

As discussed with FIG. 4 above, one or more embodiments may employ language model router 430 to route particular user requests 420 to different language models 476A-C using resource availability tables 499A-C, respectively. FIG. 5 depicts how one or more embodiments may use further classification of tasks to allow for a better matching of compute capability with specific user requests.

Categories 550A-C may be used to classify interactions with language models in terms of what type of inference is being requested, and different generalizations that may apply to the inference types, e.g., computational effort needed for the inference and the corresponding processing delay to complete the inference. For example, inferences associated with coding assistance may have a relatively small number of input tokens and a relatively large number of output tokens, while document summarization generally has the opposite token characteristics and personalized chat-based interaction may vary based on different factors specific to a user.

As depicted in FIG. 5, each of categories 550A-C includes a PE_{ReqCat}, and a t_{ReqCat}. In one or more embodiments, PE_{ReqCat}, corresponds to the estimated amount of computational processing needed to inference for the designated category 550A-C, and PE_{ReqCat}, corresponds to the estimated latency applicable to inferences for the designated category 550A-C.

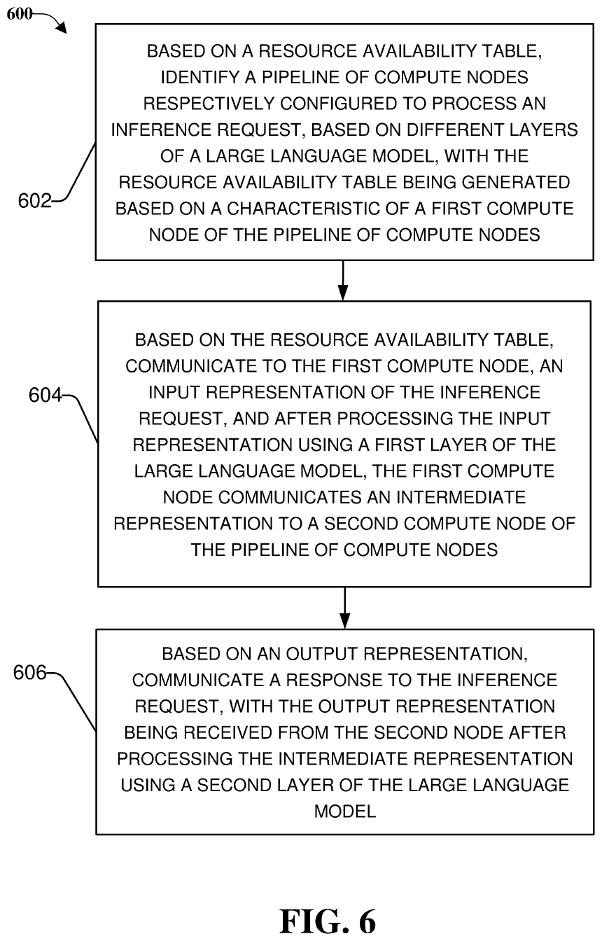

FIG. 6 depicts a flow diagram representing example operations of an example method 600 that can facilitate distributing inference with a language model to a pipeline of computing equipment, in accordance with one or more embodiments. For purposes of brevity, description of like elements and/or processes employed in other embodiments is omitted.

In some examples, one or more embodiments of method 600 can be implemented by pipeline identifier 122, pipeline controller 124, model response processor 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, pipeline identifier 122 of inference broker equipment 150 can, based on a resource availability table, identify a pipeline of compute nodes respectively configured to process an inference request, based on different layers of a large language model, with the resource availability table being generated based on a characteristic of the large language model. At 604 of method 600, pipeline controller 124 can, based on the resource availability table, communicate, by the computing equipment to a first compute node of the pipeline of compute nodes, an input representation of the inference request, and after processing the input representation using a first layer of the large language model, the first compute node communicates an intermediate representation to a second compute node of the pipeline of compute nodes. At 606 of method 600, model response processor 126 can, based on an output representation, communicate a response to the inference request, and the output representation was received from the second node after processing the intermediate representation using a second layer of the large language model.

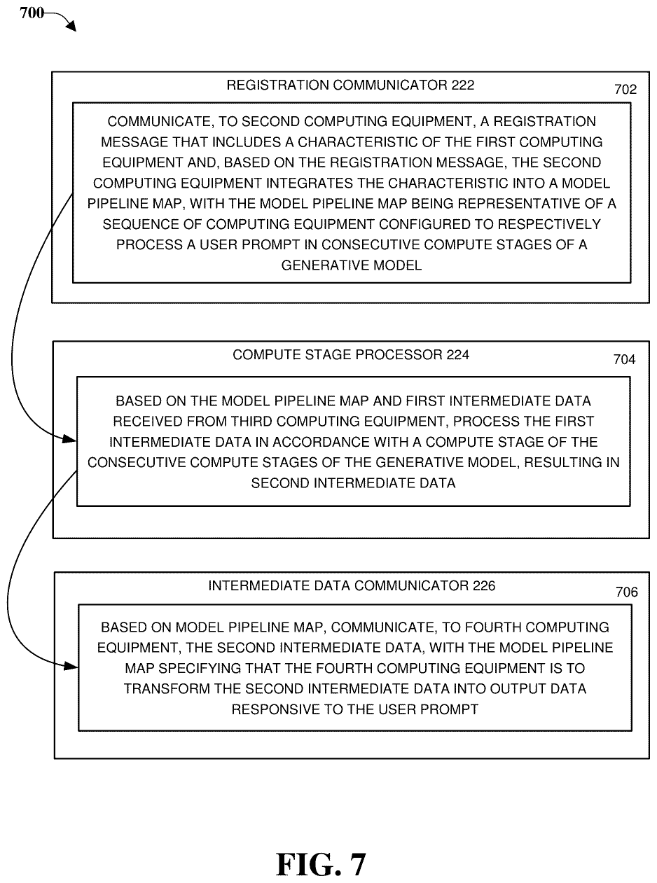

FIG. 7 depicts a flow diagram of an example system 700 that can facilitate distributing inference with a language model to a pipeline of computing equipment, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including registration communicator 222, compute stage processor 224, intermediate data communicator 226, and other components that can be used to implement aspects of system 700, as described herein, in accordance with one or more embodiments.

At 702 of FIG. 7, registration communicator 222 can communicate, to second computing equipment, a registration message that includes a characteristic of the first computing equipment and, based on the registration message, the second computing equipment integrates the characteristic into a model pipeline map, with the model pipeline map being representative of a sequence of computing equipment configured to respectively process a user prompt in consecutive compute stages of a generative model. At 704 of FIG. 7, compute stage processor 224 can, based on the model pipeline map and first intermediate data received from third computing equipment, process the first intermediate data in accordance with a compute stage of the consecutive compute stages of the generative model, resulting in second intermediate data. At 706 of FIG. 7, intermediate data communicator 226 can, based on the model pipeline map, communicate, to fourth computing equipment, the second intermediate data, with the model pipeline map specifying that the fourth computing equipment is to transform the second intermediate data into output data responsive to the user prompt.

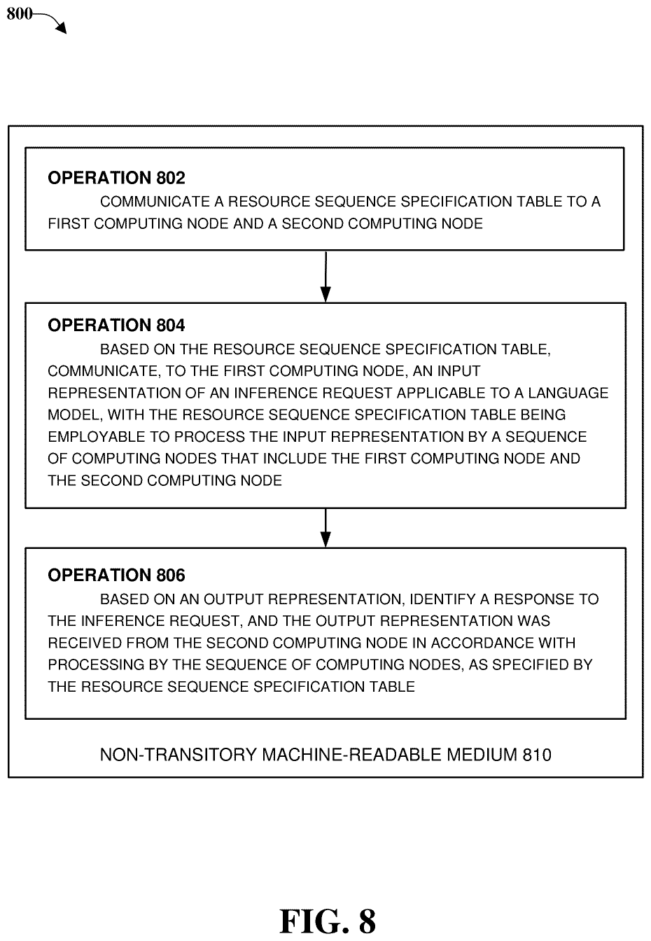

FIG. 8 depicts an example 800 non-transitory machine-readable medium 810 that can include executable instructions that, when executed by a processor of a system, can facilitate distributing inference with a language model to a pipeline of computing equipment, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can communicate a resource sequence specification table to a first computing node and a second computing node. The operations may further include operation 804 which can, based on the resource sequence specification table, communicate, to the first computing node, an input representation of an inference request applicable to a language model, with the resource sequence specification table being employable to process the input representation by a sequence of computing nodes that include the first computing node and the second computing node. The operations may further include operation 806 which can, based on an output representation, identify a response to the inference request, and the output representation was received from the second computing node in accordance with processing by the sequence of computing nodes, as specified by the resource sequence specification table.

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on a resource availability table, identifying, by computing equipment comprising at least one processor, a pipeline of compute nodes respectively configured to process an inference request, based on different layers of a large language model, wherein the resource availability table was generated based on a characteristic of a first compute node of the pipeline of compute nodes;
based on the resource availability table, communicating, by the computing equipment to the first compute node, an input representation of the inference request, wherein after processing the input representation using a first layer of the large language model, the first compute node communicates an intermediate representation to a second compute node of the pipeline of compute nodes; and
based on an output representation, communicating, by the computing equipment, a response to the inference request, wherein the output representation was received from the second node after processing the intermediate representation using a second layer of the large language model.

2. The method of claim 1, wherein the characteristic of the first compute node comprises a first characteristic, wherein the resource availability table was generated further based on a second characteristic of the large language model, comprising at least one of:
a parameter characteristic representative of a number of parameters associated with the large language model,
a layer characteristic representative of a layer depth of the large language model, or
a token characteristic representative of an average number of input tokens per inference request to the large language model.

3. The method of claim 1, wherein the second compute node was selected to receive the intermediate representation based on the resource availability table.

4. The method of claim 3, further comprising:
before the second compute node was selected, identifying, by the computing equipment, a cause to modify the pipeline of compute nodes; and
based on the cause, altering, by the computing equipment, the resource availability table to specify the second compute node to receive the intermediate representation, wherein, before the altering, the resource availability table specified another compute node, different from the second compute node, to receive the intermediate representation.

5. The method of claim 4, wherein the cause to modify the pipeline of compute nodes comprises at least one of:
a first cause representative of a dimensional incompatibility between the first compute node and the other compute node,
a second cause representative of a failure of the other compute node, or
a third cause representative of a workload of the other compute node.

6. The method of claim 1, wherein the resource availability table was generated to comprise the second compute node based on a node characteristic of the second compute node comprising at least one of:
a first node characteristic representative of a compute capacity of a graphics processor unit of the second node,
a second node characteristic representative of a reliability of the second compute node, or
a third node characteristic representative of a dimensional compatibility of the intermediate representation and the second compute node, or
a fourth node characteristic representative of a memory capacity of the second compute node.

7. The method of claim 1, further comprising:
receiving, by the computing equipment, an indication from the second node comprising at least one of:
a first indication representative of a node characteristic of the second compute node,
a second indication that the second compute node is available for inclusion in the resource availability table, or
a third indication representative of a request by the second compute node to be included in the pipeline of compute nodes.

8. The method of claim 1, further comprising:
receiving, by the computing equipment from an input representation router, a model indication comprising a designation of the large language model for usage to process the input representation; and
based on the designation, selecting, by the computing equipment, the resource availability table from available resource availability tables installed at compute nodes of the pipeline of compute nodes, resulting in a selected resource availability table, wherein the input representation further comprises table information representative of the selected resource availability table.

9. The method of claim 1, wherein parameters associated with the large language model were preloaded on the second compute node before the intermediate representation was received by the second compute node.

10. The method of claim 1, wherein the resource availability table was preloaded on the second compute node before the intermediate representation was received by the second compute node.

11. The method of claim 1, further comprising:
based on the resource availability table and an acknowledgement signal received from the first compute node, estimating, by the computing equipment, that the first compute node is not in an outage state and is capable of processing the input representation using the first layer;
receiving, by the computing equipment, a first ping signal from the second compute node, wherein the first ping signal was communicated by the second compute node in response to a second ping signal from the first compute node; and
based on the receiving of the first ping signal, determining, by the computing equipment, that the processing of the inference request by the pipeline of compute nodes is not in the outage state.

12. The method of claim 11, further comprising:
based on an indication received from the first compute node, estimating, by the computing equipment, that the second compute node is not in the outage state and is capable of the processing of the intermediate representation using the second layer.

13. The method of claim 11, wherein the acknowledgement signal comprises an acknowledgement of a receipt of a third ping signal communicated by the computing equipment, and wherein the determining that the processing of the inference request is not in the outage state resulted from analysis of a duration measured from communication of the third ping signal to receipt of the first ping signal.

14. The method of claim 1, further comprising:
identifying, by the computing equipment, a fourth compute node comprising a first capability to transform the intermediate representation using the second layer of the large language model; and
based on a comparing of a second capability of the second compute node and the first capability of the fourth compute node, specifying, by the computing equipment, in the resource availability table that the second compute node is designated to transform the intermediate representation using the second layer.

15. First computing equipment, comprising:
at least one memory that stores computer executable instructions; and
at least one processor configured to process the computer executable instructions that, when executed by the at least one processor, facilitate performance of operations, comprising:
communicating, to second computing equipment, a registration message comprising a characteristic of the first computing equipment, wherein, based on the registration message, the second computing equipment integrates the characteristic into a model pipeline map, and wherein the model pipeline map is representative of a sequence of computing equipment configured to respectively process a user prompt in consecutive compute stages of a generative model;
based on the model pipeline map and first intermediate data received from third computing equipment, processing the first intermediate data in accordance with a compute stage of the consecutive compute stages of the generative model, resulting in second intermediate data; and
based on the model pipeline map, communicating, to fourth computing equipment, the second intermediate data, wherein the model pipeline map specifies that the fourth computing equipment is to transform the second intermediate data into output data responsive to the user prompt.

16. The first computing equipment of claim 15, wherein the model pipeline map comprises a first model pipeline map that specifies that fifth computing equipment is to transform the second intermediate data into the output data, and wherein the operations further comprise:
before the first intermediate data is received, receiving the generative model and the first model pipeline map; and
before the communicating of the second intermediate data, receiving update information representative of an update to the first model pipeline map, resulting in a second model pipeline map, wherein the communicating of the second intermediate data to the fourth computing equipment resulted from the update in the second model pipeline map.

17. The first computing equipment of claim 16, wherein the generative model comprises a first generative model, wherein the sequence of computing equipment comprises a first sequence of computing equipment, and wherein the operations further comprise:
before the first intermediate data is received, receiving a second generative model and a third model pipeline map representative a second sequence of computing equipment configured to respectively process the user prompt in consecutive compute stages of the second generative model, and
before the first intermediate data is received from third computing equipment, receiving an indication that the first model pipeline map is designated to process the first intermediate data.

18. A non-transitory machine-readable medium comprising executable instructions that, when executed by at least one processor of controller node, facilitate performance of operations, the operations comprising:
communicating a resource sequence specification table to a first computing node and a second computing node;
based on the resource sequence specification table, communicating, to the first computing node, an input representation of an inference request applicable to a language model, wherein the resource sequence specification table is employable to process the input representation by a sequence of computing nodes comprising the first computing node and the second computing node; and
based on an output representation, identifying a response to the inference request, wherein the output representation was received from the second computing node in accordance with processing by the sequence of computing nodes, as specified by the resource sequence specification table.

19. The non-transitory machine-readable medium of claim 18, wherein the resource sequence specification table comprises a first resource sequence specification table, wherein the language model comprises a first language model, and wherein the operations further comprise, before the input representation is communicated, communicating to the first computing node and the second computing node:
the first language model,
a second language model, and
a second resource sequence specification table applicable to the second language model, wherein the inference request comprises a designation of the first language model as applicable to process the inference request, and wherein the communicating of the input representation to the first computing node based on the first resource sequence specification table resulted from the designation of the first language model.

20. The non-transitory machine-readable medium of claim 18, wherein the second computing node was selected for representation in the resource sequence specification table based on a predicted threshold level of reliability of the second computing node being above a threshold level of reliability.
